(19) United States
(12) Patent Application Publication
(10) Pub. No.: US 2026/0194645 A1
(43) Pub. Date: Jul. 9, 2026

(54) METHOD FOR DETERMINING POSITIONS OF SCATTERERS, COMMUNICATION DEVICE, MEDIUM AND SYSTEM

(71) Applicant: Beijing Xiaomi Mobile Software Co., Ltd., Beijing (CN)

(72) Inventors: Zhenyu ZHANG, Beijing (CN); Yumin WU, Beijing (CN); Qun ZHAO, Beijing (CN)

(73) Assignee: Beijing Xiaomi Mobile Software Co., Ltd., Beijing (CN)

(21) Appl. No.: 19/133,689

(22) PCT Filed: Nov. 30, 2022
(86) PCT No.: PCT/CN2022/135604

§ 371 Date: May 28, 2025

(51) Int. Cl. G01S 13/42; G01S 7/00

(52) U.S. Cl. CPC G01S 13/42; G01S 7/006

(57) ABSTRACT

A method and system are provided for determining the positions of scatterers within a scattering cluster in a sensing and communication system. The method may be performed by a signal transmitter, an echo receiver, or a sensing target, and includes determining scatterer positions based on angle information from a channel model and a transmission distance between the signal transmitter and the sensing target or the echo receiver and the sensing target. The angle information includes azimuth and zenith angles of departure and arrival (AOD, ZOD, AOA, ZOA), which are used to calculate included angles between signal rays and a line-of-sight (LOS) path. The method further includes using geometric relationships in a polygonal model involving the transmitter, receiver, sensing target, and scatterers to derive scatterer positions, based on included angles, vertical distances to the LOS path, and inter-scatterer distances.

### CROSS-REFERENCE TO RELATED APPLICATIONS

The present application is a U.S. National Stage of International Application No. PCT/CN2022/135604, filed on Nov. 30, 2022, the contents of which are incorporated herein by reference in their entirety for all purposes.

### BACKGROUND OF THE INVENTION

With the rapid development of wireless communication, in integrated sensing and communication (ISAC) technology, a radar system is integrated based on a traditional communication system, so a sensing function is added based on a communication function. In this way, a surrounding environment is sensed, and information such as a distance, a speed and an angle of a target in the environment is extracted. To evaluate performance of a sensing and communication system effectively, a channel model applicable to the sensing and communication system needs to be considered.

### SUMMARY OF THE INVENTION

The present disclosure relates to the technical field of mobile communication, in particular to a method for determining positions of scatterers, a communication device, a medium and a system.

According to embodiments of a first aspect of the present disclosure, a method for determining the positions of scatterers is provided. The method is performed by a signal transmitter, the echo receiver, or a sensing target in the sensing and communication system, and includes: determining positions of a plurality of scatterers within a scattering cluster, based on angle information of a channel model and a transmission distance between the signal transmitter and the sensing target or the echo receiver and the sensing target.

According to embodiments of a second aspect of the present disclosure, a method for determining the positions of the scatterers is provided. The method is performed by the sensing and communication system. The sensing and communication system includes the signal transmitter, the echo receiver, and the sensing target. The method includes: determining the positions of the plurality of scatterers within the scattering cluster, by the signal transmitter or the sensing target, based on the angle information of the channel model and the transmission distance between the signal transmitter and the sensing target or the echo receiver and the sensing target, for a path from the signal transmitter to the sensing target; and determining the positions of the plurality of scatterers within the scattering cluster, by the sensing target or the echo receiver, based on the angle information of the channel model and the transmission distance between the signal transmitter and the sensing target or the echo receiver and the sensing target, for a path from the sensing target to the echo receiver.

According to embodiments of a third aspect of the present disclosure, a communication device is provided. The communication device includes:
a memory that stores a computer program; and one or more processors;
where the computer program, when collectively executed by the one or more processors, causes the communication device to:
determine the positions of the plurality of scatterers within the scattering cluster, based on the angle information of the channel model and the transmission distance between the signal transmitter and the sensing target or the echo receiver and the sensing target.

According to embodiments of a fourth aspect of the present disclosure, a non-transitory computer storage medium is provided. The non-transitory computer storage medium stores computer-executable instructions. The computer-executable instructions, when executed by a processor, implement the method according to the embodiments of first aspect of the present disclosure.

According to embodiments of a fifth aspect of the present disclosure, a sensing and communication system is provided. The sensing and communication system includes: a signal transmitter, an echo receiver, and a sensing target. The sensing and communication system is configured to perform the method according to the embodiments of the present disclosure.

Additional aspects and advantages of the present disclosure will be given in part in the following description, in part as will become apparent from the following description or as will be learned through the practice of the present disclosure.

### BRIEF DESCRIPTION OF DRAWINGS

The foregoing and/or additional aspects and advantages of the present disclosure will become apparent and easily understandable from the following descriptions of embodiments with reference to the accompanying drawings.

FIG. 1 is a schematic flowchart of a method for determining a position of a scattering cluster according to an embodiment of the present disclosure;

FIG. 2 is a schematic spatial diagram for determining the position of the scattering cluster in a channel for a sensing and communication system according to an embodiment of the present disclosure;

FIG. 3 is a schematic spatial diagram of an azimuth angle of departure (AOD) and a zenith angle of departure (ZOD) according to an embodiment of the present disclosure;

FIG. 4 is a schematic diagram of an elliptical plane for determining the position of the scattering cluster according to an embodiment of the present disclosure;

FIG. 5 is a schematic diagram of an effect of the position of the scattering cluster according to an embodiment of the present disclosure;

FIG. 6 is a schematic flowchart of a method for determining positions of scatterers according to an embodiment of the present disclosure;

FIG. 7 is a schematic flowchart of a method for determining the positions of the scatterers according to an embodiment of the present disclosure;

FIG. 8 is a schematic diagram of two-hop within the scattering cluster according to an embodiment of the present disclosure;

FIG. 9 is a schematic flowchart of a method for determining the positions of the scatterers according to an embodiment of the present disclosure;

FIG. 10 is a schematic flowchart of a method for determining the positions of the scatterers according to an embodiment of the present disclosure;

FIG. 11 is a schematic block diagram of a device for determining the positions of the scatterers according to an embodiment of the present disclosure;

FIG. 12 is a schematic structural diagram of a communication device according to an embodiment of the present disclosure; and

FIG. 13 is a schematic structural diagram of a chip according to an embodiment of the present disclosure.

### DETAILED DESCRIPTION OF THE INVENTION

The following describes in detail embodiments of the present disclosure, and examples of the embodiments are shown in the accompanying drawings. Identical or similar reference numerals throughout denote identical or similar elements or elements having identical or similar functions. The embodiments described below with reference to the accompanying drawings are examples intended to explain the present disclosure, and cannot be understood as any limitation on the present disclosure.

In recent years, an integrated sensing and communication (ISAC) technology has developed rapidly. In the integrated sensing and communication technology, a radar system is integrated based on a traditional communication system, so that the communication system has both a communication function and a sensing function and may be configured to sense information such as a distance, a speed and an angle of a target in a surrounding environment. To effectively evaluate the performance of a sensing and communication system, a channel model applicable to the sensing and communication system needs to be considered.

In the existing 3rd generation partnership project (3GPP) technical report (TR) 38.901, a channel model for the communication system is provided, namely, a unidirectional path from a signal transmitter to a target (i.e., a signal receiver). However, the positions of scattering clusters determined by the sensing and communication systems may coincide. Currently, there is no good solution for accurately positioning a plurality of scatterers within a scattering cluster.

However, in the sensing and communication system, in addition to a forward path from the signal transmitter to the target, there is also a reverse path from the target to an echo receiver. In a case where an active radar (i.e., a scenario where A transmits and A receives) is considered, the signal transmitter and the echo receiver are a same object. In a case where a passive radar (i.e., a scenario where A transmits and B receives) is considered, the signal transmitter and the echo receiver are different objects. However, channel modeling needs to be performed for the reverse path from the target to the echo receiver for both an active radar system and a passive radar system.

The channel model in the existing TR 38.901 may be used as a starting point of research. A classical clustered delay line (CDL) channel model and a fast fading channel model are provided in the existing TR 38.901. In the channel model, interference of a signal from the signal transmitter to the target is statistically simulated by using a scattering cluster in an environment. A CDL channel is used as an example, and the same applies to a fast fading channel. Because a line of sight (LOS) path is usually considered in the radar system, two types of CDL channels, namely CDL-D and CDL-E, which include the LOS path, are considered. The CDL channel usually includes a plurality of scattering clusters. Each scattering cluster has a plurality of information, including a normalized delay, a power, an azimuth angle of departure (AOD), an azimuth angle of arrival (AOA), a zenith angle of departure (ZOD), a zenith angle of arrival (ZOA), and the like.

However, an angle of departure in the CDL channel represents only an angle from a transmitter to first reflection, and an angle of arrival represents only an angle from last reflection to a receiver. Therefore, the information of the scattering cluster cannot directly represent a position of the scattering cluster. For example, the position of the scattering cluster is calculated based on the AOD, the AOA, the ZOD, and the ZOA, a total distance of a path corresponding to this position may not match a total distance calculated based on a delay.

In the PCT patent application No. PCT/CN2022/131230, entitled SCATTERING CLUSTER POSITION DETERMINATION METHOD, APPARATUS AND SYSTEM and filed on Nov. 10, 2022, a solution for determining the position of the scattering cluster is provided, which resolves a currently unresolved problem of modeling the position of the scattering cluster in a channel for the sensing and communication system. Specifically, for the CDL channel model, the fast fading channel model, or a trapped delay line (TDL) channel to which angle information is introduced, as shown in FIG. 1, the position of the scattering cluster may be determined, by using S001, based on at least one of angle of the channel model or delay information of the channel model. The specific solution for determining the position of the scattering cluster includes the following three manners:
determining the position of the scattering cluster based on the AOD, the ZOD, the AOA, and the ZOA;
determining the position of the scattering cluster based on the AOD, the ZOD, and normalized delay information; and
determining the position of the scattering cluster based on the AOA, the ZOA, and the normalized delay information.

A specific implementation of the solution (1) is as follows:

The CDL channel is used as an example. Because only the LOS path is usually considered in a traditional radar system, the present solution is for a CDL-D channel with the LOS path and a CDL-E channel with the LOS path. Based on the CDL channel model in 3GPP, Table 1 shows information such as an angle and a delay of each scattering cluster in the CDL-D channel provided in 3GPP TR 38.901, including the LOS path and 12 scattering clusters.

TABLE 1
Parameter table for the scattering cluster

| | | Norm- | Power | AOD | AOA | ZOD | ZOA |
|---|---|---|---|---|---|---|---|
| Scattering | Cluster | alized | in | in | in | in | in |
| cluster | PAS | delay | [dB] | [°] | [°] | [°] | [°] |
| 1 | LOS path | 0 | −0.2 | 0 | −180 | 98.5 | 81.5 |
| | Laplacian | 0 | −13.5 | 0 | −180 | 98.5 | 81.5 |
| 2 | Laplacian | 0.035 | −18.8 | 89.2 | 89.2 | 85.5 | 86.9 |
| 3 | Laplacian | 0.612 | −21 | 89.2 | 89.2 | 85.5 | 86.9 |
| 4 | Laplacian | 1.363 | −22.8 | 89.2 | 89.2 | 85.5 | 86.9 |
| 5 | Laplacian | 1.405 | −17.9 | 13 | 163 | 97.5 | 79.4 |
| 6 | Laplacian | 1.804 | −20.1 | 13 | 163 | 97.5 | 79.4 |
| 7 | Laplacian | 2.596 | −21.9 | 13 | 163 | 97.5 | 79.4 |
| 8 | Laplacian | 1.775 | −22.9 | 34.6 | −137 | 98.5 | 78.2 |
| 9 | Laplacian | 4.042 | −27.8 | −64.5 | 74.5 | 88.4 | 73.6 |
| 10 | Laplacian | 7.937 | −23.6 | −32.9 | 127.7 | 91.3 | 78.3 |
| 11 | Laplacian | 9.424 | −24.8 | 52.6 | −119.6 | 103.8 | 87 |
| 12 | Laplacian | 9.708 | −30.0 | −132.1 | −9.1 | 80.3 | 70.6 |
| 13 | Laplacian | 12.525 | −27.7 | 77.2 | −83.8 | 86.5 | 72.9 |

Table 1 shows information such as the angles and the delays of all scattering clusters in the CDL-D channel in Table 7.7.1-4 in 3GPP TR 38.901. Cluster PAS (Power angular spectrum) is a cluster angular power spectrum. Laplacian is Laplace distribution, and LOS path is a line of sight path (or referred to as a direct path).

In this solution, determining the position of the scattering cluster based on the AOD, the ZOD, the AOA, and the ZOA specifically includes: determining an included angle γ between a transmitted signal ray and the LOS path based on the AOD and the ZOD; determining an included angle γ′ between a received signal ray and the LOS path based on the AOA and the ZOA; determining an intersection point between the transmitted signal ray and the received signal ray, and determining a position of the intersection point as the position of the scattering cluster.

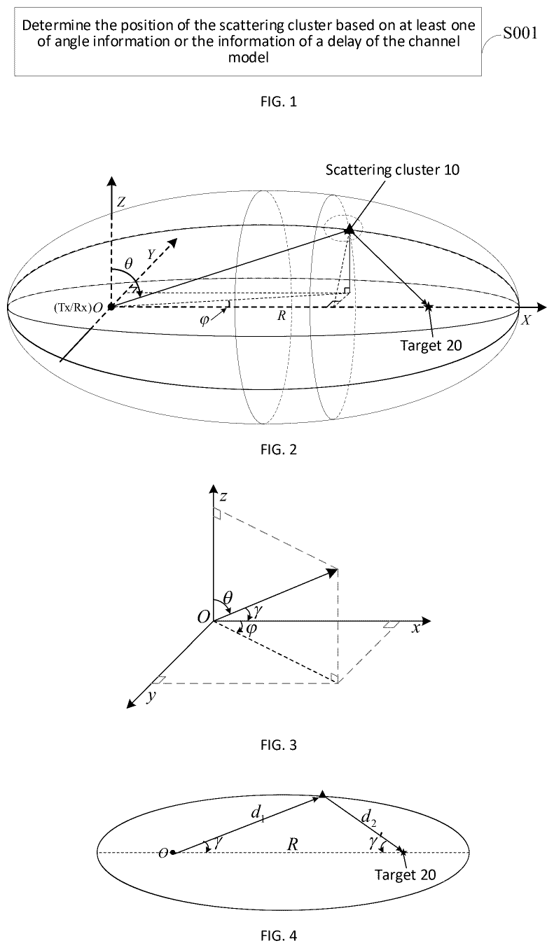

Specifically, as shown in FIG. 2 and FIG. 3, the AOD is represented as φ, the ZOD is represented as θ, and the included angle γ=cos⁻¹(cos φ sin θ) between the transmitted signal ray and the LOS path may be determined. Similarly, the AOA is represented as φ′, the ZOA is represented as θ′, the included angle γ′=cos⁻¹(cos φ′ sin θ′) between the signal arriving ray and the LOS path may be determined.

Further, it is assumed that the obtained γ and γ′ are on a same plane. The plane may be represented as an ellipse shown in FIG. 4 based on FIG. 2. In a cross section of the ellipse, specifically, in the CDL channel model scenario shown in FIG. 2, the signal transmitter or the echo receiver is located at an origin O(0,0,0), the target 20 is located at (R, 0,0). The target may be referred to as the sensing target. FIG. 4 shows the cross section of the ellipse on which the signal transmitter or the echo receiver, the sensing target, the transmitted signal ray, and the received signal ray in FIG. 2 are located. Therefore, one intersection point may be determined based on the transmitted signal ray and the received signal ray, and the intersection point is the position of the scattering cluster 10.

Specifically, slopes k₁=tan γ, k₂=tan γ′ of the transmitted signal ray and the received signal ray may be determined based on the included angle γ between the transmitted signal ray and the LOS path and the included angle γ′ between the signal arriving ray and the LOS path. The intersection point may be calculated via simultaneous equations of the transmitted signal ray and the received signal ray, and the intersection point is the position of the scattering cluster.

An effect of determining the position of the scattering cluster according to the present solution is shown in FIG. 5. FIG. 5 shows positions of the scattering clusters calculated based on angle information of different scattering clusters from 1 to 12. In the figure, a diamond represents a position of the signal transmitter or the echo receiver, a pentagram represents a position of the sensing target, and 12 black circles in the middle represent the generated positions of the scattering clusters. The position of the scattering cluster at which the transmitted signal ray and the received signal ray intersect in the distance is on a right side, and transmitted signal rays and received signal rays corresponding to the scattering clusters 1, 2, and 3 are almost parallel to each other. Positions of the scattering clusters 1, 2, and 3 coincide with each other, and positions of the scattering clusters 4, 5, and 6 coincide with each other. The reason is that angle information for generating the positions of the scattering clusters is completely the same.

Therefore, in a case where the position of the scattering cluster is determined based on the angle information of the channel model, positions of a plurality of clusters may coincide, that is, the plurality of clusters have same angle information. For example, the second, third, and fourth scattering clusters in the CDL-D channel have same AOD, AOA, ZOD, and ZOA, and therefore, the positions of the scattering clusters determined based on the angle information according to the above solution (1) may coincide. Currently, for this problem, there is no good solution to how to accurately position a plurality of scatterers within the scattering cluster.

In view of this, a method and device for determining positions of scatterers, a communication device, a medium and a system are provided in the present disclosure. For unidirectional or bidirectional multipath channel modeling for the sensing and communication system, a multi-hop manner within the scattering cluster is considered, and the positions of the plurality of scatterers within the scattering cluster are determined. This is used to resolve a problem that the scattering clusters coincide in a case where the plurality of clusters have same angle information.

According to the present disclosure, a method and device for determining positions of scatterers, a communication device, a medium and a system are provided. Bidirectional multipath channel modeling based on the sensing and communication system includes the reverse path from the target to the echo receiver, considers the multi-hop manner within the scattering cluster, and determines positions of the plurality of scatterers within the scattering cluster. This is well-suited for the channel model for the sensing and communication system.

It is to be noted that because the TDL channel has no angle information, the CDL channel model or the fast fading channel model is used as an example in this solution, and the same applies to the present solution if the angle information is introduced to the TDL channel.

It is to be understood that the solution provided in the present disclosure may be used for a fifth generation mobile communication technology (5G) and subsequent communication technologies, such as 5G-advanced and a sixth generation mobile communication technology (6G). This is not limited to the present disclosure.

The following describes in detail a solution for determining positions of scatterers provided in the present disclosure with reference to the accompanying drawings.

FIG. 1 is a schematic flowchart of a method for determining positions of scatterers according to an embodiment of the present disclosure. As shown in FIG. 1, the method is performed by the signal transmitter, the echo receiver, or the sensing target in the sensing and communication system. For ease of understanding, Table 1 shows a schematic diagram of parameter setting for the CDL channel model, and FIG. 2 is a schematic diagram of the position of the scattering cluster in the channel for the sensing and communication system based on the CDL channel.

In embodiments of the present disclosure, the signal transmitter and the echo receiver may be a base station (BS) or a terminal. The echo receiver needs a function of a radar. The sensing target may be the base station, the terminal, or an object in an environment. The signal transmitter and the echo receiver may be the same device or different devices.

It is to be understood that because the sensing and communication system needs to model an echo signal and perform sensing by using the echo signal and a sensing algorithm, a bidirectional channel model different from a channel model for an existing communication system needs to be constructed. In the present disclosure, the position of the scattering cluster determined in a unidirectional process (including a forward direction from the signal transmitter to the sensing target and a reverse direction from the sensing target to the echo receiver) may be used for an entire bidirectional process, or the position of the scattering cluster may be determined independently in the forward direction and the reverse direction. In other words, for the forward direction, the solution of the present disclosure may be performed by the signal transmitter or the sensing target, and the position of the scattering cluster determined by the signal transmitter or the sensing target may be used for the reverse direction. Similarly, for the reverse direction, the solution of the present disclosure may be performed by the sensing target or the echo receiver. The above solution is applicable regardless of whether the transmitter and the receiver are the same device or different devices. Cases of the present disclosure are described one by one with reference to the accompanying drawings.

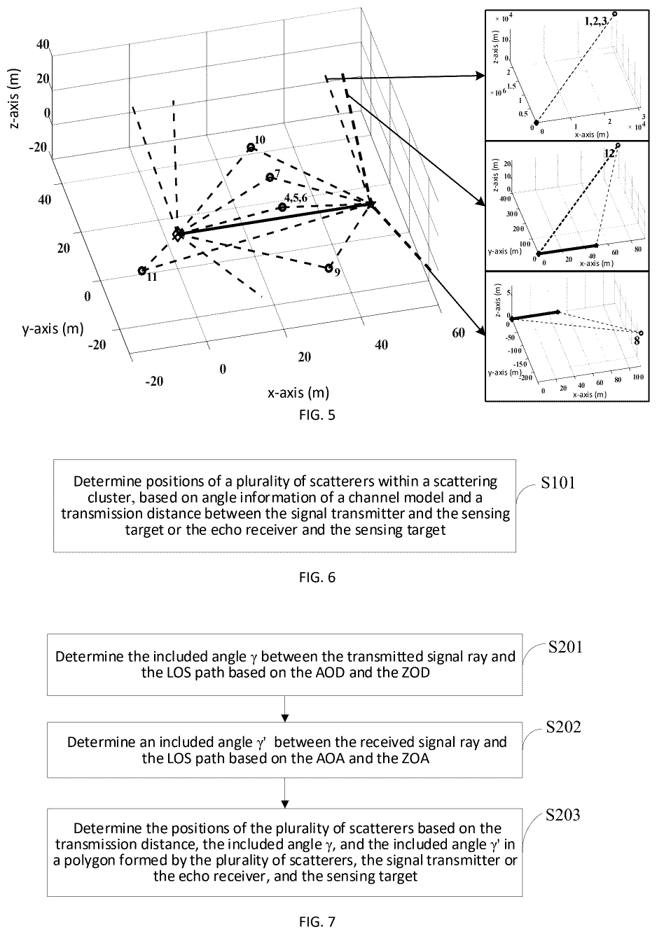

The embodiment described with reference to FIG. 6 is for the first case, that is, the position of the scattering cluster is determined in the unidirectional process. The position may be used for the unidirectional process or the entire bidirectional process. As shown in FIG. 6, the method includes the following step.

S101: determine positions of a plurality of scatterers within a scattering cluster, based on angle information of a channel model and a transmission distance between the signal transmitter and the sensing target or the echo receiver and the sensing target.

The channel model is the CDL channel model or the fast fading channel model.

It is to be noted that the angle information and the delay information of the CDL channel or the fast fading channel model are detailed in the existing 3GPP TR 38.901. As shown in Table 1, according to the 3GPP protocol, the information of the scattering cluster cannot directly describe the position of the scattering cluster. In a case where the position of the scattering cluster is determined based on the angle information of the channel, positions of scattering clusters may coincide.

Specifically, as shown in Table 1, the second, third, and fourth scattering clusters in the CDL-D channel have same AOD, AOA, ZOD, and ZOA, and the fifth, sixth, and seventh scattering clusters in the CDL-D channel have same AOD, AOA, ZOD, and ZOA. In a case where positions of the scattering clusters are determined based on the above four pieces of angle information, positions of the three scattering clusters coincide. According to the present disclosure, a case of multi-hop scatterers within the scattering cluster is considered. The positions of the plurality of scatterers within the scattering cluster are determined, based on the angle information of the channel model and the transmission distance between the signal transmitter and the sensing target or the echo receiver and the sensing target. Therefore, according to this solution, channel modeling is performed with the consideration of the multi-hop within the scattering cluster. In this way, a problem that the scattering clusters coincide can be resolved, and the positions of the plurality of scatterers within the scattering cluster are determined.

In embodiments of the present disclosure, the angle information includes the AOD, the ZOD, the AOA, and the ZOA. The angle of departure only describes an angle from the transmitter to first refraction, and the angle of arrival only describes an angle from last refraction to the receiver. The transmission distance between the signal transmitter and the sensing target or the echo receiver and the sensing target is a total distance from the signal transmitter or the echo receiver to the scattering cluster, through the plurality of scatterers within the scattering cluster, and then to the sensing target.

Referring to FIG. 2, it is assumed that for a certain multipath, the AOD of is φ, the ZOD is θ, the AOA is φ′, the ZOA is θ′, and the distances between the signal transmitter and the sensing target, and between the echo receiver and the sensing target are both R. It is assumed that in the CDL channel model scenario, the signal transmitter or the echo receiver is located at the origin O(0,0,0), and the sensing target is located at (R, 0,0) (on an X-axis). It can be learned that on the LOS path, the AOD is φ_{LOS}=0°, the ZOD is θ_{LOS}=90°, the AOA is φ′=−180°, and the ZOD is θ′=90°. In this case, the transmission distance between the signal transmitter and the LOS sensing target or the echo receiver and the sensing target is R+Delay*c, where Delay represents a delay, delay information, and c represents a speed of light.

In embodiments of the present disclosure, considering that the multi-hop manner within the scattering cluster is applicable to determine positions of the plurality of scatterers within the scattering cluster based on the angle information and the transmission distance between the signal transmitter and the sensing target or the echo receiver and the sensing target, in cases of two-hop, three-hop, four-hop, and so on. The transmission distance between the signal transmitter and the sensing target or the echo receiver and the sensing target may be determined based on a distance between the signal transmitter and sensing target or the echo receiver and sensing target, the speed of light, and the delay information. An executing entity may be the signal transmitter, the echo receiver, or the sensing target in the sensing and communication system.

This is not limited to the present disclosure.

In conclusion, according to the method for determining the positions of the scatterers provided in embodiments of the present disclosure, the signal transmitter, the echo receiver, or the sensing target in the sensing and communication system determines the positions of the plurality of scatterers within the scattering cluster, based on the angle information of the channel model and the transmission distance between the signal transmitter and the sensing target or the echo receiver and the sensing target. Bidirectional multipath channel modeling for the sensing and communication system is used to position multi-hop scatterers within a plurality of clusters in a case where the plurality of clusters have same angle information.

Additionally, the bidirectional multipath channel modeling based on the sensing and communication system includes the reverse path from the target to the echo receiver, considers the multi-hop manner within the scattering cluster, and determines positions of the plurality of scatterers within the scattering cluster. This is well-suited for the channel model for the sensing and communication system.

FIG. 7 is a schematic flowchart of a method for determining the positions of the scatterers according to an embodiment of the present disclosure. The method is performed by a signal entity in the sensing and communication system or the sensing target. The signal entity includes the signal transmitter or the echo receiver. In embodiments of the present disclosure, the signal transmitter and the echo receiver may be different entities or a same entity, that is, one signal entity is both the signal transmitter and the signal receiver.

Based on the embodiment shown in FIG. 6, in a case where the angle information includes the AOD, the ZOD, the AOA, and the ZOA, the embodiment shown in FIG. 7 is an optional solution. As shown in FIG. 7, the method may include the following steps.

S201: determine the included angle γ between the transmitted signal ray and the LOS path based on the AOD and the ZOD.

In embodiments of the present disclosure, it is assumed that for the multipath, the AOD is represented as φ, and the ZOD is represented as θ. The included angle γ between the transmitted signal ray and the LOS path may be determined. Specific calculation is shown in Formula (1).

$$γ = {cos}^{- 1} ( cos φ sin θ ) \qquad ( 1 )$$

S202: determine the included angle γ′ between the received signal ray and the LOS path based on the AOA and the ZOA.

In embodiments of the present disclosure, it is assumed that for the multipath, the AOA is represented as φ′, and the ZOA is represented as θ′. The included angle γ′ between the signal arriving ray and the LOS path may be determined. Specific calculation is shown in Formula (2).

$${γ}^{′} = {cos}^{- 1} ( cos {φ}^{′} sin {θ}^{′} ) \qquad ( 2 )$$

S203: determine the positions of the plurality of scatterers based on the transmission distance, the included angle γ, and the included angle γ′ in a polygon formed by the plurality of scatterers, the signal entity, and the sensing target.

It is to be noted that the present disclosure considers multi-hop positions within the scattering cluster, and determines the positions of the plurality of scatterers within the scattering cluster. It is mainly used to resolve a problem of positioning the multi-hop scatterers in a case where the positions of the scattering clusters in the multipath coincide. It may also be used in other cases where the positions of the plurality of scatterers within the scattering cluster need to be determined. The cases are not limited to the present disclosure.

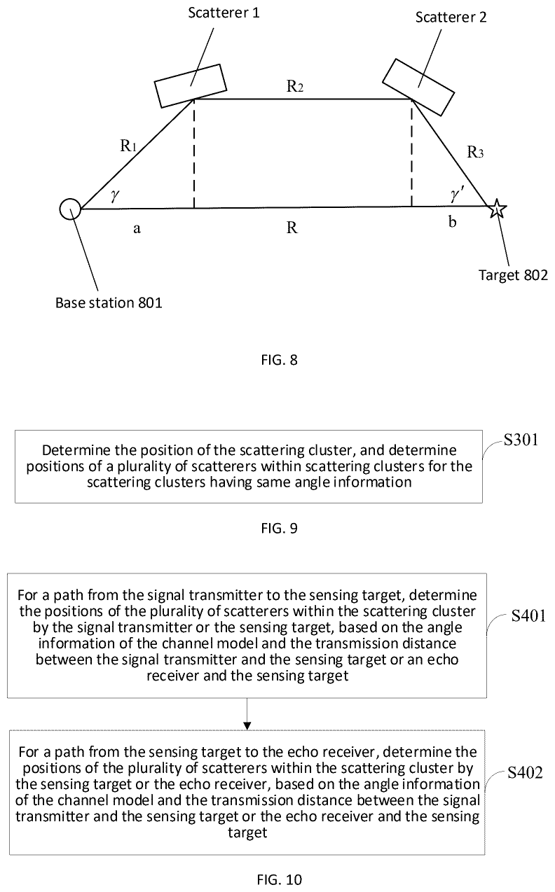

In one embodiment of the present disclosure, FIG. 8 is a schematic diagram of two-hop positions of the scattering cluster. The scattering cluster includes two scatterers. In this scenario, a scatterer 1, a scatterer 2, the signal entity, and the sensing target form a polygon shown in FIG. 8. In this polygon, positions of the scatterer 1 and the scatterer 2 may be determined, based on the transmission distance, the included angle γ, and the included angle γ′. In embodiments of the present disclosure, a trapezoid is formed by the scatterer 1, the scatterer 2, the signal entity, and the sensing target as an example. It is to be understood that the polygon may be any shape other than the trapezoid. This is not limited to the present disclosure. The signal entity includes the signal transmitter or the echo receiver.

In embodiments of the present disclosure, in a case where the positions of the scattering clusters in the multipath coincide, a distance between the plurality of scatterers within the scattering cluster corresponding to a path with a larger delay is shorter. For example, as shown in FIG. 8, in a case where the positions of the scattering clusters in the multipath coincide, corresponding included angles γ and included angles γ′ are the same. For the path with the larger delay, a trapezoid with a same bottom side and an unequal height relative to the trapezoid shown in FIG. 8 is formed. The path with the larger delay corresponds to a trapezoid with a larger height, and a distance between the scatterer 1 and the scatterer 2 is shorter.

For example, in a case where the positions of the scattering clusters in the multipath coincide such as the second, third, and fourth scattering clusters in the CDL-D channel shown in Table 1.

Since the AOD, the AOA, the ZOD, and the ZOA are the same, and after correction is performed merely based on the four pieces of angle information, determined positions of the three scattering clusters coincide. However, it can be learned from Table 1 that the second, third, and fourth scattering clusters have different normalized delays, and therefore, the delay information is also different. The delays of the second, third, and fourth scattering clusters increase sequentially, and the transmission distances become longer. Because transmitted signal ray and the received signal ray are the same, the distance between the plurality of scatterers is shorter.

In some embodiments of the present disclosure, the transmission distance between the signal entity and the sensing target is determined based on a distance between the signal entity (the signal transmitter or the echo receiver) and the sensing target, the speed of the light, and the delay information.

Specifically, Table 1 shows normalized delays corresponding to the multipath in the channel model provided in 3GPP TR 38.901. A corresponding delay may be determined based on a delay scaling factor. It is assumed that a delay corresponding to a n-th path is τₙ, and the distance between the signal transmitter and the sensing target or the echo receiver and the sensing target is R, and the transmission distance that is between the signal transmitter and the sensing target or the echo receiver and the sensing target and that corresponds to the n-th path is Rₙ=R+τₙc, where c is the speed of the light.

In some embodiments of the present disclosure, the step S203 includes: determining slopes of the transmitted signal ray and the received signal ray based on the included angle γ and the included angle γ′; determining a distance R₁ from the signal transmitter to a first scatterer that the transmitted signal ray passes through or from the sensing target to a first scatterer that the received signal ray passes through, a distance R₂ from a last scatterer that the transmitted signal ray passes through to the sensing target or from a last scatterer that the received signal ray passes through to the echo receiver, and a distance R₃ between the plurality of scatterers, based on the slopes of the transmitted signal ray and the received signal ray, and the transmission distance; and determining the positions of the plurality of scatterers based on R₁, R₂, and R₃.

It is to be understood that a number of the plurality of scatterers described in the present disclosure is two or more. In a case where there are two scatterers, R₃ is the distance between the two scatterers, and there is one value of R₃. In a case where there are more than two scatterers, R₃ is the distance between the plurality of scatterers, there are a plurality of values of R₃, and the plurality of values of distances are not limited to values of distances between adjacent scatterers. This is not limited to the present disclosure.

In embodiments of the present disclosure, the slopes of the transmitted signal ray and the received signal ray may be respectively determined as tan γ and tan γ′ based on the included angle γ and the included angle γ′.

In embodiments of the present disclosure, for a forward path from the signal transmitter to the sensing target, the distance R₁ from the signal transmitter to the first scatterer that the transmitted signal ray passes through, the distance R₂ from the last scatterer that the transmitted signal ray passes through to the sensing target, and the distance R₃ between the plurality of scatterers are determined, based on the slopes of the transmitted signal ray and the received signal ray, and the transmission distance. For a return path from the sensing target to the echo receiver, the distance R₁ from the sensing target to the first scatterer that the received signal ray passes through, the distance R₂ from the last scatterer that the received signal ray passes through to the echo receiver, and the distance R₃ between the plurality of scatterers are determined, based on the slopes of the transmitted signal ray and the received signal ray, and the transmission distance.

It is to be noted that the above method is applicable to a case of the multi-hop positions within the scattering cluster, including cases where the number of scatterers within the scattering cluster is two, three, four, or the like. An example of two-hop positions within the scattering cluster is used in the following. There are two scatterers, and reflection via two scatterers for each cluster is considered. However, this does not constitute any limitation on applicability of the present disclosure to more hops.

In embodiments of the present disclosure, in a case where the number of the plurality of scatterers is two and a connection line between the plurality of scatterers is parallel to the LOS path, determining the positions of the plurality of scatterers based on the transmission distance, the included angle γ, and the included angle γ′ includes: determining vertical distances from the plurality of scatterers to the LOS path by determining vertical lines from the plurality of scatterers to the LOS path; and determining the positions of the plurality of scatterers based on the vertical distances, the transmission distance, the included angle γ and the included angle γ′.

In embodiments of the present disclosure, in a two-hop position model for the scattering cluster shown in FIG. 8, the number of the plurality of scatterers is two, including the scatterer 1 and the scatterer 2, and the connection line between the plurality of scatterers is parallel to the LOS path.

The base station 801 may be determined as at least one of the signal transmitter or the echo receiver, and the target 802 refers to the sensing target. The figure shows the included angle γ between the transmitted signal ray and the LOS path, the included angle γ′ between the received signal ray and the LOS path, the slope tan γ of the transmitted signal ray, and the slope tan γ′ of the received signal ray.

It is assumed that the LOS path from the base station 801 to the target 802 is R, a distance between the base station 801 and the scatterer 1 is R₁, a distance between the scatterer 1 and the scatterer 2 is R₂, and a distance between the scatterer 2 and the target 802 is R₃. A vertical line is determined from the scatterer 1 to the LOS path and intersects with the LOS path at a point. A distance between the point and the base station 801 is a. A vertical line is determined from the scatterer 2 to the LOS path and intersects with the LOS path at a point. A distance between the point and the target 802 is b. The following equation may be obtained:

$$\{ \begin{matrix}a tan γ = b tan {γ}^{′} \\ {R}_{1} = \frac{a}{cos γ} \\ {R}_{2} = \frac{b}{cos {γ}^{′}} \\ {R}_{1} + {R}_{2} + {R}_{3} - R = Delay * c \\ {R}_{2} = R - a - b\end{matrix} \qquad ( 3 )$$

The transmission distance between the base station 801 (the signal transmitter or the echo receiver) and the sensing target is R₁+R₂+R₃. R₁+R₂+R₃−R=Delay*c may be determined based on the LOS path R from the base station 801 to the target 802, the delay information Delay, and the speed of the light c. Values of R₁, R₂, R₃, a, and b may be calculated based on the above formula and geometric features.

In embodiments of the present disclosure, in a case where the number of the plurality of scatterers is two and the connection line between the plurality of scatterers is not parallel to the LOS path, determining the positions of the plurality of scatterers based on the transmission distance, the included angle γ, and the included angle γ′ includes: determining an included angle between the LOS path and the connection line between the plurality of scatterers; determining a plurality of vertical distances from the plurality of scatterers to the LOS path by determining vertical lines from the plurality of scatterers to the LOS path respectively; and determining the positions of the plurality of scatterers, based on the plurality of vertical distances, the transmission distance, the included angle between the LOS path and the connection line between the plurality of scatterers, the included angle γ, and the included angle γ′.

In embodiments of the present disclosure, in a case where the number of the plurality of scatterers is two and the connection line between the plurality of scatterers is not parallel to the LOS path, the included angle between the LOS path and the connection line between the plurality of scatterers is first determined. A parallel line to the LOS path is determined based on the scatterer 1 or the scatterer 2, and the parallel line intersects at a point on the transmitted signal ray or the received signal ray. In this case, the same method for the case where the connection line between the plurality of scatterers is parallel to the LOS path may be used to determine R₁, R₂, R₃, and a value of the vertical distance corresponding to the scatterer 1 or the scatterer 2, and then determine a position of the scatterer 1 or the scatterer 2. Then, a position of another scatterer may be obtained based on the included angle between the LOS path and the connection line between the plurality of scatterers. For details of a specific calculation method, reference is made to the embodiment corresponding to FIG. 8.

In conclusion, according to the method for determining the position of the scattering cluster provided in embodiments of the present disclosure, and the method is performed by the signal entity in the sensing and communication system or the sensing target. That is, the method may be performed by the signal transmitter, the signal receiver, or the sensing target. The method includes: determining the included angle γ between the transmitted signal ray and the LOS path based on the AOD and the ZOD; determining the included angle γ′ between the received signal ray and the LOS path based on the AOA and the ZOA; and determining the positions of the plurality of scatterers based on the transmission distance, the included angle γ, and the included angle γ′ in a polygon formed by the plurality of scatterers, the signal transmitter or the echo receiver, and the sensing target. Bidirectional multipath channel modeling for the sensing and communication system includes the reverse path from the target to the echo receiver, considers the multi-hop manner within the scattering cluster, and determines the positions of the plurality of scatterers within the scattering cluster. In this way, a problem that the positions of the scattering clusters in multipath coincide can be resolved.

FIG. 9 is a schematic flowchart of a method for determining the positions of the scatterers according to an embodiment of the present disclosure. The method is performed by the signal entity in the sensing and communication system or the sensing target. Based on embodiments shown in FIG. 6 and FIG. 7, as shown in FIG. 9, the method may include the following step.

S301: determine the position of the scattering cluster, and determine positions of a plurality of scatterers within scattering clusters for the scattering clusters having same angle information.

It is to be noted that the present disclosure may be based on a method for determining the position of the scattering cluster applicable to the CDL channel or the fast fading channel for the sensing and communication system. The method includes determining the position of the scattering cluster based on the angle information. In a case where there are a plurality of clusters in the CDL channel having same angle information, for example, considering the second, third, and fourth scattering clusters in the CDL-D channel, which have the same AOD, AOA, ZOD, ZOA, the positions of the three scattering clusters coincide.

Based on this, the multi-hop manner within the scatterers is considered in embodiments of the present disclosure. For scattering clusters having same angle information, a two-hop manner or the multi-hop manner may be used to determine a position. The specific method is based on the embodiments shown in FIG. 6 to FIG. 8 of the present disclosure. Details are not described herein.

It is to be understood that for scattering clusters having different angle information, a single-hop manner, a two-hop manner, or the multi-hop manner may be used to determine the position. The single-hop manner is used to determine a unique position of the scatterer, and details are not described herein. The two-hop manner or the multi-hop manner is determined based on the methods shown in FIG. 6 to FIG. 8 of the present disclosure.

In conclusion, according to the method for determining the positions of the scatterers provided in embodiments of the present disclosure, which is performed by the signal transmitter, the echo receiver, or the sensing target in the sensing and communication system. A method for determining multi-hop spatial positions within the scattering cluster in channel modeling for the sensing and communication system is provided in the present disclosure. This method achieves accurate positioning of multi-hop scatterers within an environment and is well-suited for the channel model for the sensing and communication system.

FIG. 10 is a schematic flowchart of a method for determining the positions of the scatterers according to an embodiment of the present disclosure. The method is performed by the sensing and communication system. The sensing and communication system includes the signal transmitter, the echo receiver, and the sensing target. According to the embodiment described with reference to FIG. 10, a solution for determining the positions of the scatterers in the bidirectional process is provided. It is to be noted that the solution may be implemented separately or may be implemented with solutions of other embodiments of the present disclosure. For example, typically, the solution may be implemented with the solution including step S201 to step S203, the solution including step S301, or the solution including step S201 to step S203 and the solution including step S301.

It is to be understood that according to the solution of the present disclosure, the position of the scattering cluster may be first determined. The position of the scattering cluster is determined based on at least one of the angle information or the delay information of the channel model.

Specifically, the solution may include three manners:
determining the position of the scattering cluster based on the AOD, the ZOD, the AOA, and the ZOA;
determining the position of the scattering cluster based on the AOD, the ZOD, and the normalized delay information; and
determining the position of the scattering cluster based on the AOA, the ZOA, and the normalized delay information.

In the present disclosure, for a case where positions of scattering clusters determined by using the manner (1) coincide, positions of the multi-hop scatterers are positioned.

It is to be understood that the present solution may be applied to the unidirectional path from the transmitter to the target or from the target to the receiver, or applied to a bidirectional path from the transmitter to the target and then to the receiver. For a case of the bidirectional path, the position of the scattering cluster may be determined by using one or two of the above solutions. Solutions used in fronthaul and backhaul may be the same or different. For example, the scattering cluster from the base station to the target is determined by using the solution 1, and the scattering cluster from the target to the base station is determined by using the solution 2 or the solution 3. For the fronthaul, the positions of the multi-hop scatterers may be determined by using the solution provided in the present disclosure.

In the present disclosure, the signal transmitter and the echo receiver may be the base station or the terminal. The echo receiver needs the function of the radar, and the sensing target may be the base station or the terminal, or the object in the environment.

In the present disclosure, the signal transmitter and the echo receiver may be a same device or different devices. For example, if a mobile communication base station has a function of an active radar that can transmit a signal and receive a signal, the base station may be determined as both the signal transmitter and the echo receiver. In this case, the signal transmitter and the echo receiver are the same device. The base station may be determined as either the signal transmitter or the echo receiver. In this case, the signal transmitter and the echo receiver are different devices. A passive radar can merely receive the signal. Because the passive radar as the echo receiver cannot actively transmit the signal, the signal transmitter and the echo receiver are different devices.

As shown in FIG. 10, the method may include at least one of step S401 or step S402.

S401: for a path from the signal transmitter to the sensing target, determine the positions of the plurality of scatterers within the scattering cluster by the signal transmitter or the sensing target, based on the angle information of the channel model and the transmission distance between the signal transmitter and the sensing target or the echo receiver and the sensing target.

S402: for a path from the sensing target to the echo receiver, determine the positions of the plurality of scatterers within the scattering cluster by the sensing target or the echo receiver, based on the angle information of the channel model and the transmission distance between the signal transmitter and the sensing target or the echo receiver and the sensing target.

In embodiments of the present disclosure, the positions of the scatterers determined for the path from the signal transmitter to the sensing target in step S401 and the positions of the scatterers determined for the path from the sensing target to the echo receiver in step S402 are used for channel modeling for the bidirectional path in the sensing and communication system. The bidirectional path is formed form the signal transmitter to the sensing target and then to the echo receiver. The positions of the scatterers determined in the step S401 may be the same as or different from the positions of the scatterers determined in the step S402. The number of hops considered in a case where the positions of the scatterers are determined by using the step S401 may be the same as or different from the number of hops considered in a case where the positions of the scatterers are determined by using the step S402. The method for determining the positions of the plurality of scatterers within the scattering cluster used in step S401 may be the same as or different from the method for determining the positions of the plurality of scatterers within the scattering cluster used in step S402.

It is to be understood that because the sensing and communication system needs to model an echo signal and perform sensing by using the echo signal and the sensing algorithm. The bidirectional channel model different from the channel model for the existing communication system needs to be constructed. The bidirectional path includes the path from the signal transmitter to the sensing target and the path from the sensing target to the echo receiver. The present embodiment describes a solution for determining the positions of the plurality of scatterers within the scattering cluster in the forward direction and the reverse direction, that is, a process in which the method for determining the positions of the plurality of scatterers within the scattering cluster is bidirectionally performed.

In embodiments of the present disclosure, in a case where the signal transmitter and the echo receiver are the same device, for the path from the signal transmitter to the sensing target, the signal transmitter or the sensing target may determine the positions of the plurality of scatterers within the scattering cluster by using the methods described in the embodiments of FIG. 6 to FIG. 8. For the path from the sensing target to the echo receiver, modeling may not be performed, and a model for the path from the signal transmitter to the sensing target may be directly used.

Alternatively, in the optional solution described in this embodiment, the sensing target or the echo receiver may determine the positions of the plurality of scatterers within the scattering cluster for the reverse process by using the methods described in the embodiments of FIG. 6 to FIG. 8.

In the present disclosure, for details of the specific method for determining the positions of the plurality of scatterers within the scattering cluster, reference is made to related descriptions of the embodiments of FIG. 6 to FIG. 8. Details are not described in the present disclosure again.

It is to be noted that if the signal transmitter and the echo receiver are the same device, the positions of the scatterers determined by the transmitter in the forward process may be the same as the positions of the scatterers determined by the sensing target. Therefore, the positions of the scatterers determined by the transmitter in the forward process may be used directly for modeling the reverse process or may be re-determined by the sensing target. If the positions of the scatterers are determined by the sensing target in the forward process, the positions of the scatterers may be re-determined by the receiver in the reverse process or modeling is performed directly based on the positions of the scatterers determined in the forward process. The same applies if the transmitter and the receiver are different devices. Details are not described herein again.

In conclusion, according to the embodiments of the present disclosure, a method for determining positions of scatterers is provided. The method is performed by the sensing and communication system. The sensing and communication system includes the signal transmitter, the echo receiver, and the sensing target. The method includes: for the path from the signal transmitter to the sensing target, determining the positions of the plurality of scatterers within the scattering cluster by the signal transmitter or the sensing target, based on the angle information of the channel model and the transmission distance between the signal transmitter and the sensing target or the echo receiver and the sensing target; and for the path from the sensing target to the echo receiver, determining the positions of the plurality of scatterers within the scattering cluster by the sensing target or the echo receiver, based on the angle information of the channel model and the transmission distance between the signal transmitter and the sensing target or the echo receiver and the sensing target. According to the present disclosure, a modeling method for the multi-hop within the scattering cluster in a bidirectional multipath channel for the sensing and communication system is provided, to describe channel multipath experienced by the echo signal in the sensing and communication system. In addition, the multi-hop manner for the scatterers is considered, to determine the positions of the plurality of scatterers within the scattering cluster, so that the method is applicable to the sensing and communication system.

In the foregoing embodiments provided in the present disclosure, the methods provided in embodiments of the present disclosure are described. To implement the functions of the methods provided in embodiments of the present disclosure, both a network device and a terminal device may include a hardware structure and a software module, to implement the functions in a form of the hardware structure, the software module, or a combination of the hardware structure and the software module. One of the foregoing functions may be performed by using the hardware structure, the software module, or the combination of the hardware structure and the software module.

According to the present disclosure, a device for determining the positions of the scatterers corresponding to the method for determining the positions of the scatterers provided in the above several embodiments is further provided. Because the device for determining the positions of the scatterers provided in this embodiment of the present disclosure corresponds to the method for determining the positions of the scatterers provided in the above several embodiments, implementations of the method for determining the positions of the scatterers are also applicable to the device for determining the positions of the scatterers provided in this embodiment. Details are not described in this embodiment.

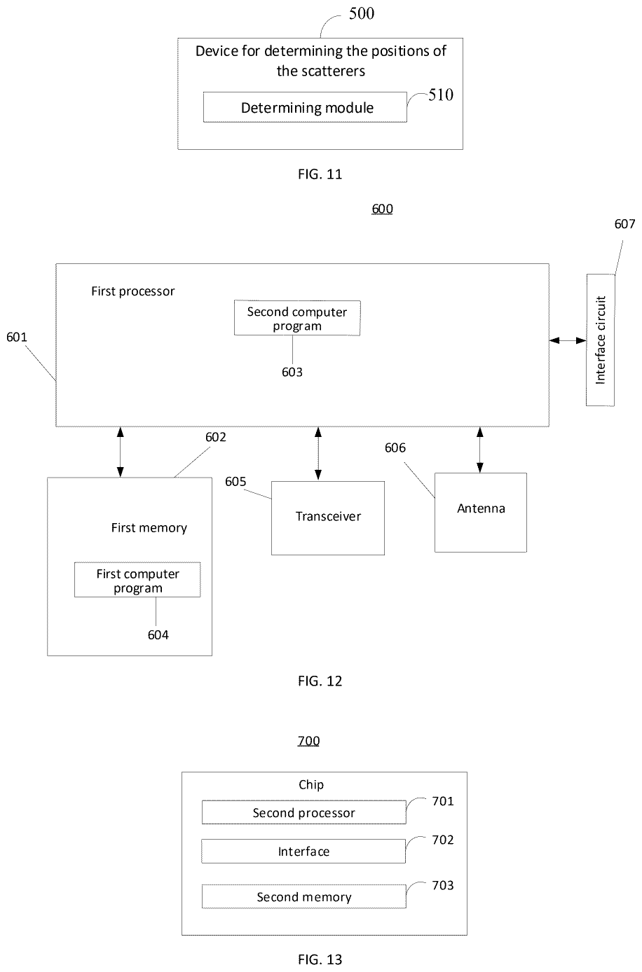

FIG. 11 is a schematic structural diagram of a device 500 for determining the positions of the scatterers according to an embodiment of the present disclosure. As shown in FIG. 11, the device 500 may include: a determining module 510, configured to determine the positions of the plurality of scatterers within the scattering cluster based on the angle information of the channel model and the transmission distance between the signal transmitter and the sensing target or the echo receiver and the sensing target.

According to the device for determining the positions of the scatterers provided in embodiments of the present disclosure, the positions of the plurality of scatterers within the scattering cluster are determined, based on the angle information of the channel model and the transmission distance between the signal transmitter and the sensing target or the echo receiver and the sensing target. A solution for determining the multi-hop spatial positions within the scattering cluster is provided, which is applicable to the channel modeling for the sensing and communication system, so that the scattering cluster in the environment is accurately positioned.

The solution is well-suited for the channel modeling for the sensing and communication system.

In some embodiments, the angle information includes the AOD, the ZOD, the AOA, and the ZOA, the device 500 is further configured to: determine the included angle γ between the transmitted signal ray and the LOS path based on the AOD and the ZOD; and determine the included angle γ′ between the received signal ray and the LOS path based on the AOA and the ZOA.

In some embodiments, the determining module 510 is further configured to: determine the positions of the plurality of scatterers based on the transmission distance, the included angle γ, and the included angle γ′ in the polygon formed by the plurality of scatterers, the signal transmitter or the echo receiver, and the sensing target.

In some embodiments, the device 500 is further configured to: determine the slopes of the transmitted signal ray and the received signal ray based on the included angle γ and the included angle γ′; determine the distance R₁ from the signal transmitter to the first scatterer that the transmitted signal ray passes through or from the sensing target to the first scatterer that the received signal ray passes through, the distance R₂ from the last scatterer that the transmitted signal ray passes through to the sensing target or from the last scatterer that the received signal ray passes through to the echo receiver, and the distance R₃ between the plurality of scatterers, based on the slopes of the transmitted signal ray and the received signal ray, and the transmission distance; and determine the positions of the plurality of scatterers based on R₁, R₂, and R₃.

In some embodiments, the number of the plurality of scatterers is two. The connection line between the plurality of scatterers is parallel to the LOS path. Accordingly, the determining module 510 is further configured to: determine the vertical distances from the plurality of scatterers to the LOS path by determining the vertical lines from the plurality of scatterers to the LOS path; and determine the positions of the plurality of scatterers based on the vertical distances, the transmission distance, the included angle γ, and the included angle γ′.

In some embodiments, in a case where the positions of the scattering clusters in the multipath coincide, the distance between the plurality of scatterers within the scattering cluster corresponding to the path with the larger delay is shorter.

In some embodiments, the number of the plurality of scatterers is two. The connection line between the plurality of scatterers is not parallel to the LOS path. Accordingly, the determining module 510 is further configured to: determine the included angle between the LOS path and the connection line between the plurality of scatterers; determine the plurality of vertical distances from the plurality of scatterers to the LOS path by determining the vertical lines from the plurality of scatterers to the LOS path respectively; and determine the positions of the plurality of scatterers based on the plurality of vertical distances, the transmission distance, the included angle between the LOS path and the connection line between the plurality of scatterers, the included angle γ, and the included angle γ′.

In some embodiments, the device 500 is further configured to: determine the transmission distance between the signal transmitter and the sensing target or the echo receiver and the sensing target, based on the distance between the signal transmitter and sensing target or the echo receiver and sensing target, the speed of the light, and the delay information.

In some embodiments, the device 500 is further configured to: determine the position of the scattering cluster and determine the positions of the plurality of scatterers within scattering clusters for the scattering clusters having same angle information.

In conclusion, according to the device for determining the positions of the scatterers provided in embodiments of the present disclosure, the positions of the plurality of scatterers within the scattering cluster are determined, based on the angle information of the channel model and the transmission distance between the signal transmitter and the sensing target or the echo receiver and the sensing target. The solution for determining the multi-hop spatial positions within the scattering cluster is provided, which is applicable to the channel modeling for the sensing and communication system, so that the scattering cluster in the environment is accurately positioned.

The solution is well-suited for the channel modeling for the sensing and communication system.

According to the present disclosure, a sensing and communication system is provided. The sensing and communication system includes the signal transmitter, the echo receiver, and the sensing target. The sensing and communication system is configured to perform the method described in the embodiment of FIG. 10 of the present disclosure, to determine the positions of the plurality of scatterers within the scattering cluster and construct a bidirectional multipath channel model for multi-hop scatterers.

According to an embodiment of the present disclosure, a communication system is further provided. The system includes the device for determining the positions of the scatterers shown in the embodiment of FIG. 11 and is configured to perform the method for determining the positions of the scatterers described in the embodiments of FIG. 6 to FIG. 10.

Reference is made to FIG. 12, which is a schematic structural diagram of a communication device 600 according to an embodiment of the present disclosure. The communication device 600 may be the network device, may be a user equipment, may be a chip, a chip system, a processor, or the like that supports the network device in implementing the foregoing methods, or may be a chip, a chip system, a processor, or the like that supports the user equipment in implementing the foregoing methods. The device may be configured to implement the methods described in the foregoing method embodiments. For details, reference is made to the descriptions in the foregoing method embodiments.

The communication device 600 may include one or more first processors 601. The first processor 601 may be a general-purpose processor or a dedicated processor, for example, may be a baseband processor or a central processing unit. The baseband processor may be configured to process a communication protocol and communication data. The central processing unit may be configured to control a communication device (e.g., the base station, a baseband chip, the terminal device, a chip of the terminal device, a distributed unit (DU) or a centralized unit (CU), etc.), execute a computer program, and process data of the computer program.

In some examples, the communication device 600 may further include one or more first memories 602. The first memory 602 may store a first computer program 604. The first processor 601 executes the first computer program 604 to cause the communication device 600 to perform the methods described in the foregoing method embodiments. In some examples, the first memory 602 may further store data. The communication device 600 and the first memory 602 may be separately disposed, or may be integrated.

In some examples, the communication device 600 may further include a transceiver 605 and an antenna 606. The transceiver 605 may be referred to as a transceiver unit, a transceiver machine, a transceiver circuit, or the like, and is configured to implement a receiving or sending function.

The transceiver 605 may include a receiver and a transmitter. The receiver may be referred to as a receiver machine, a receiver circuit, or the like, and is configured to implement a receiving function. The transmitter may be referred to as a transmitter machine, a transmitter circuit, or the like, and is configured to implement a sending function.

In some examples, the communication device 600 may further include one or more interface circuits 607. The interface circuit 607 is configured to receive code instructions and transmit the code instructions to the first processor 601. The first processor 601 is configured to run the code instructions to cause the communication device 600 to perform the methods described in the foregoing method embodiments.

In an implementation, the first processor 601 may include a transceiver configured to implement the receiving and sending functions. For example, the transceiver may be a transceiver circuit, an interface, or an interface circuit. The transceiver circuit, the interface, or the interface circuit configured to implement the receiving and sending functions may be separated, or may be integrated. The transceiver circuit, the interface, or the interface circuit may be configured to read and write code or data. Alternatively, the transceiver circuit, the interface, or the interface circuit may be configured to transmit or transfer a signal.

In an implementation, the first processor 601 may store a second computer program 603. The second computer program 603 is run on the first processor 601 to cause the communication device 600 to perform the methods described in the foregoing method embodiments. The second computer program 603 may be fixed in the first processor 601. In this case, the first processor 601 may be implemented by hardware.

In an implementation, the communication device 600 may include a circuit, and the circuit may implement a sending, receiving, or communication function in the foregoing method embodiments. The processor and the transceiver described in the present disclosure may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and the transceiver may alternatively be manufactured by using various IC technologies, for example, a complementary metal oxide semiconductor (CMOS), an N-metal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the foregoing embodiment may be the network device or the user equipment, but a scope of the communication device described in the present disclosure is not limited to this, and a structure of the communication device may not be limited to FIG. 12. The communication device may be an independent device or may be a part of a large device. For example, the communication device may be:
(1) an independent integrated circuit IC, a chip, or a system or subsystem on chip;
(2) a set including one or more ICs, in some examples, the set of ICs may further include a storage component configured to store data and a computer program;
(3) the ASIC, for example, a Modem;
(4) a module that can be embedded in another device;
(5) the receiver machine, the terminal device, a smart terminal device, a cellular phone, a wireless device, a handset, a mobile unit, a vehicle-mounted device, the network device, a cloud device, an artificial intelligence device, or the like; and
(6) another device or the like.

In a case where the communication device is the chip or the system on chip, reference is made to a schematic structural diagram of a chip 700 shown in FIG. 13. The chip 700 shown in FIG. 13 includes a second processor 701 and an interface 702. There may be one or more second processors 701, and there may be a plurality of interfaces 702.

In some examples, the chip further includes a second memory 703, and the second memory 703 is configured to store a necessary computer program and date.

A person skilled in the art may further understand that various illustrative logical blocks and steps that are listed in embodiments of the present application may be implemented by using electronic hardware, computer software, or a combination of electronic hardware and computer software.

Whether the functions are implemented by using hardware or software depends on particular applications and a design requirement of the entire system. A person skilled in the art may use various methods to implement the described functions for each particular application, but it is not to be considered that the implementation goes beyond the protection scope of embodiments of the present application.

As used herein, the term processor may refer to one processor that performs the defined functions or a plurality of processors that collectively perform defined functions, such that the execution of the individual defined functions may be divided amongst such processors.

According to the present application, a non-transitory computer-readable storage medium is provided. The readable storage medium stores instructions. When the instructions are executed by a computer, functions of any one of the foregoing method embodiments are implemented.

All or some of the foregoing embodiments may be implemented by using software, hardware, firmware, or any combination thereof. When software is used to implement the embodiments, all or some of the embodiments may be implemented in a form of a computer program product.

The computer program product includes one or more computer programs. When the computer program is loaded and executed on a computer, all or some of the procedures or functions according to embodiments of the present disclosure are generated. The computer may be a general-purpose computer, a dedicated computer, a computer network, or another programmable device. The computer program may be stored in a non-transitory computer-readable storage medium or may be transmitted from a non-transitory computer-readable storage medium to another non-transitory computer-readable storage medium. For example, the computer program may be transmitted from a website, computer, server, or data center to another website, computer, server, or data center in a wired (e.g., a coaxial cable, an optical fiber, or a digital subscriber line (DSL)) or wireless (e.g., infrared, radio, microwave, etc.) manner. The non-transitory computer-readable storage medium may be any usable medium accessible by a computer, or a data storage device, such as a server or a data center, integrating one or more usable media. The usable medium may be a magnetic medium (e.g., a floppy disk, a hard disk, or a magnetic tape), an optical medium (e.g., a digital video disc (DVD)), a semiconductor medium (e.g., a solid state disk (SSD)), or the like.

A person of ordinary skill in the art may understand that various numbers such as first and second in the present application are merely used for differentiation for ease of description, and are not used to limit the scope of embodiments of the present application, and also represent an order.

In the present disclosure, “at least one” may also be described as “one or more,” and “a plurality of” may be “two, three, four, or more”. This is not limited to the present disclosure. In embodiments of the present disclosure, for a technical feature, “first,” “second,” “third,” “A,” “B,” “C,” “D,” etc. are used to distinguish between technical features in the technical feature, and there is no sequential order or size order between the technical features described by “first,” “second,” “third,” “A,” “B,” “C,” and “D”.

As used herein, the terms “machine-readable medium“and” non-transitory computer-readable medium” refer to at least one of: a computer program product, equipment, or a device (e.g., a disk, an optical disc, a memory, a programmable logic device (PLD)). Each of these is configured to provide at least one of machine instructions or data to a programmable processor and includes a machine-readable medium capable of receiving machine instructions as machine-readable signals. The term “machine-readable signal” refers to any signal used to provide at least one of the machine instructions or the data to the programmable processor.

The system and technologies described here may be implemented on a computing system (e.g., as a data server) that includes a back-end component, a computing system (e.g., an application server) that includes a middleware component, a computing system (e.g., a user computer that has a graphical user interface or a web browser, through which the user may interact with the system and technologies described here) that includes a front-end component, or a computing system that includes any combination of the back-end component, the middleware component, or the front-end component. The components of the system may be connected to each other through digital data communication (e.g., a communication network) in any form or medium. For example, the communication network includes a local area network (LAN), a wide area network (WAN), and an Internet.

The computer system may include a client and a server. The client and the server are generally away from each other and interact with each other through the communication network. A client-server relationship is established by running, on corresponding computers, computer programs that have the client-server relationship.

It is to be understood that various forms of processes shown above can be used to reorder, add, or delete steps. For example, the steps described in the present disclosure may be performed in parallel, or may be performed in sequence, or may be performed in different sequences, provided that an expected result of the technical solutions in the present disclosure can be implemented.

This is not limited herein.

In addition, it is to be understood that various embodiments of the present disclosure may be implemented separately or may be implemented in combination with other embodiments as the solution permits.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it is not to be considered that the implementation goes beyond the scope of the present disclosure.

It may be clearly understood by a person skilled in the art that, for convenient and brief description, for a detailed working process of the foregoing system, device, and unit, reference is made to a corresponding process in the foregoing method embodiments. Details are not described herein again.

The foregoing descriptions are merely specific implementations of the present application, but are not intended to limit the protection scope of the present application. Any variation or replacement readily figured out by a person skilled in the art within the technical scope disclosed in the present disclosure shall fall within the protection scope of the present application.

Therefore, the protection scope of the present application shall be subject to the protection scope of the claims.

1. A method for determining positions of scatterers, performed by a signal transmitter, an echo receiver, or a sensing target in a sensing and communication system, the method comprising:
determining positions of a plurality of scatterers within a scattering cluster, based on angle information of a channel model and a transmission distance between the signal transmitter and the sensing target or the echo receiver and the sensing target.

2. The method according to claim 1, wherein the angle information comprises an azimuth angle of departure (AOD), a zenith angle of departure (ZOD), an azimuth angle of arrival (AOA), and a zenith angle of arrival (ZOA); wherein
the method further comprises:
determining an included angle γ between a transmitted signal ray and a line of sight (LOS) path based on the AOD and the ZOD; and
determining an included angle γ′ between a received signal ray and the LOS path based on the AOA and the ZOA.

3. The method according to claim 1, wherein determining the positions of the plurality of scatterers within the scattering cluster comprises:
determining the positions of the plurality of scatterers based on the transmission distance, an included angle γ between a transmitted signal ray and a LOS path and an included angle γ′ between a received signal ray and the LOS path in a polygon formed by the plurality of scatterers, the signal transmitter or the echo receiver, and the sensing target.

4. The method according to claim 3, further comprising:
determining slopes of a transmitted signal ray and a received signal ray based on the included angle γ and the included angle γ′;
determining a distance R₁ from the signal transmitter to a first scatterer that the transmitted signal ray passes through or from the sensing target to a first scatterer that the received signal ray passes through, a distance R₂ from a last scatterer that the transmitted signal ray passes through to the sensing target or from a last scatterer that the received signal ray passes through to the echo receiver, and a distance R₃ between the plurality of scatterers, based on the slopes of the transmitted signal ray and the received signal ray, and the transmission distance; and
determining the positions of the plurality of scatterers based on R₁, R₂ and R₃.

5. The method according to claim 3, wherein a number of the plurality of scatterers is two and a connection line between the plurality of scatterers is parallel to the LOS path; wherein
determining the positions of the plurality of scatterers based on the transmission distance, the included angle γ and the included angle γ′ comprises:
determining vertical distances from the plurality of scatterers to the LOS path by determining vertical lines from the plurality of scatterers to the LOS path; and
determining the positions of the plurality of scatterers based on the vertical distances, the transmission distance, the included angle γ and the included angle γ′.

6. The method according to claim 5, wherein in a case where positions of scattering clusters in multipath coincide, a distance between a plurality of scatterers within a scattering cluster corresponding to a path with a larger delay is shorter.

7. The method according to claim 3, wherein a number of the plurality of scatterers is two and a connection line between the plurality of scatterers is not parallel to the LOS path; wherein
determining the positions of the plurality of scatterers based on the transmission distance, the included angle γ and the included angle γ′ comprises:
determining an included angle between the LOS path and the connection line between the plurality of scatterers;
determining a plurality of vertical distances from the plurality of scatterers to the LOS path by determining vertical lines from the plurality of scatterers to the LOS path respectively; and
determining the positions of the plurality of scatterers, based on the plurality of vertical distances, the transmission distance, the included angle between the LOS path and the connection line between the plurality of scatterers, the included angle γ and the included angle γ′.

8. The method according to claim 1, further comprising:
determining the transmission distance between the signal transmitter and the sensing target or the echo receiver and the sensing target, based on a distance between the signal transmitter and the sensing target or the echo receiver and the sensing target, a speed of light, and delay information.

9. The method according to claim 1, further comprising:
determining a position of the scattering cluster; and
determining positions of a plurality of scatterers within scattering clusters for the scattering clusters having same angle information.

10. A method for determining positions of scatterers, performed by a sensing and communication system,
the method comprising:
determining positions of a plurality of scatterers within a scattering cluster, by a signal transmitter or a sensing target, based on angle information of a channel model and a transmission distance between the signal transmitter and the sensing target or an echo receiver and the sensing target, for a path from the signal transmitter to the sensing target; and
determining the positions of the plurality of scatterers within the scattering cluster, by the sensing target or the echo receiver, based on the angle information of the channel model and the transmission distance between the signal transmitter and the sensing target or the echo receiver and the sensing target, for a path from the sensing target to the echo receiver.

11. (canceled)

12. A communication device, comprising:
a memory that stores a computer program; and
one or more processors;
wherein the computer program, when collectively executed by the one or more processors, causes the communication device to:
determine positions of a plurality of scatterers within a scattering cluster, based on angle information of a channel model and a transmission distance between a signal transmitter and a sensing target or an echo receiver and the sensing target.

13. A non-transitory computer storage medium storing computer-executable instructions, wherein the computer-executable instructions, when executed by a processor, implement the method according to claim 1.

14. A sensing and communication system, comprising:
the signal transmitter;
the echo receiver; and
the sensing target;
wherein the sensing and communication system is configured to perform the method according to claim 10.

15. The communication device according to claim 12, wherein the angle information comprises an azimuth angle of departure (AOD), a zenith angle of departure (ZOD), an azimuth angle of arrival (AOA), and a zenith angle of arrival (ZOA); wherein
the communication device is further configured to:
determine an included angle γ between a transmitted signal ray and a line of sight (LOS) path based on the AOD and the ZOD; and
determine an included angle γ′ between a received signal ray and the LOS path based on the AOA and the ZOA.

16. The communication device according to claim 12, wherein the communication device is further configured to:
determine the positions of the plurality of scatterers based on the transmission distance, an included angle γ between a transmitted signal ray and a LOS path and an included angle γ′ between a received signal ray and the LOS path in a polygon formed by the plurality of scatterers, the signal transmitter or the echo receiver, and the sensing target.

17. The communication device according to claim 16, wherein the communication device is further configured to:
determine slopes of the transmitted signal ray and the received signal ray based on the included angle γ and the included angle γ′;
determine a distance R₁ from the signal transmitter to a first scatterer that the transmitted signal ray passes through or from the sensing target to a first scatterer that the received signal ray passes through, a distance R₂ from a last scatterer that the transmitted signal ray passes through to the sensing target or from a last scatterer that the received signal ray passes through to the echo receiver, and a distance R₃ between the plurality of scatterers, based on the slopes of the transmitted signal ray and the received signal ray, and the transmission distance; and
determine the positions of the plurality of scatterers based on R₁, R₂ and R₃.

18. The communication device according to claim 16, wherein a number of the plurality of scatterers is two and a connection line between the plurality of scatterers is parallel to the LOS path; wherein
the communication device is further configured to:
determine vertical distances from the plurality of scatterers to the LOS path by determining vertical lines from the plurality of scatterers to the LOS path; and
determine the positions of the plurality of scatterers based on the vertical distances, the transmission distance, the included angle γ and the included angle γ′.

19. The communication device according to claim 18, wherein in a case where positions of scattering clusters in multipath coincide, a distance between a plurality of scatterers within a scattering cluster corresponding to a path with a larger delay is shorter.

20. The communication device according to claim 16, wherein a number of the plurality of scatterers is two and a connection line between the plurality of scatterers is not parallel to the LOS path; wherein
the communication device is further configured to:
determine an included angle between the LOS path and the connection line between the plurality of scatterers;
determine a plurality of vertical distances from the plurality of scatterers to the LOS path by determining vertical lines from the plurality of scatterers to the LOS path respectively; and
determine the positions of the plurality of scatterers, based on the plurality of vertical distances, the transmission distance, the included angle between the LOS path and the connection line between the plurality of scatterers, the included angle γ and the included angle γ′.

21. The communication device according to claim 12, wherein the communication device is further configured to:
determine the transmission distance between the signal transmitter and the sensing target or the echo receiver and the sensing target, based on a distance between the signal transmitter and the sensing target or the echo receiver and the sensing target, a speed of light, and delay information.
